(19) United States
(12) Patent Application Publication
(10) Pub. No.: US 2025/0143360 A1
(43) Pub. Date: May 8, 2025

(54) OLFACTORY SYSTEM AND METHODS

(71) Applicant: Charles Isgar, Scottsdale, AZ (US)

(72) Inventor: Charles Isgar, Scottsdale, AZ (US)

(21) Appl. No.: 18/935,783

(22) Filed: Nov. 4, 2024

Related U.S. Application Data
(60) Provisional application No. 63/595,869, filed on Nov. 3, 2023.

(51) Int. Cl. A23L 27/20; G06Q 30/0601

(52) U.S. Cl. CPC A23L 27/204; G06Q 30/0631

(57) ABSTRACT

An olfactory system is provided. The olfactory system includes an olfactory device having a processing unit, a water reservoir, and a heating element. The system also includes an olfactory medium inserted within the olfactory device and located in a path of fluid flow from the water reservoir and out a nozzle of the olfactory device. The system further includes an olfactory receptacle. In operation, the olfactory device is controlled by the processing unit to heat water from the water reservoir and dispenses the hot water through the olfactory medium and out of a nozzle to create a hot olfactory liquid that is received in the olfactory receptacle to produce olfactory steam providing aroma to a dwelling.

### CROSS REFERENCE TO RELATED APPLICATION

This application claims priority to U.S. Provisional Patent Application Ser. No. 63/595,869, filed Nov. 3, 2024, the disclosure of which is hereby incorporated entirely herein by reference.

### BACKGROUND OF THE INVENTION

### Technical Field

This invention relates generally to an olfactory device and more particularly to an olfactory system and method of supplying aroma related to particular meals, such as meal deliveries.

### State of the Art

It is understood that our sense of smell is responsible for about 80% of what we taste. Without our sense of smell, our sense of taste is limited to only five distinct sensations: sweet, salty, sour, bitter and umami (or savory sensation). Generally, all other flavors are experienced from smell. Smell and taste are part of the same interconnected sensory system, and “flavor” is almost entirely sensed in the nose. Smell (olfactory sense) and taste (gustatory sense) fall work in similar ways. Additionally, the flavor of food is almost entirely detected in the nose and not the tongue. The taste receptors on the tongue and the odorant receptors in the nose work together to tell us about the air we breathe and the food we eat.

Many bakeries will use a vent from the oven and pump the scent into the front of the store, so as soon as a customer walks in, he or she can smell a freshly baked good, which in turn can help with impulse sales and increase revenue. Subconsciously, just by smell, customers are compelled to buy something. A scent has triggered memory, and that memory has triggered a sale before anything has even been tasted.

There does not exist a system where an individual can provide the aroma of a meal being cooked within a home when food is delivered. Because of this, it is difficult, if not impossible to appreciate the feeling of a home cooked meal when the aromas associated with cooking those meals are not present in a home or apartment. This is becoming more and more important as there are more working individuals and more households where all of the members of the household work, leaving less time for preparing a home-cooked meal. There is not an available system or method that provides the olfactory component of a home-cooked meal for meals that are delivered and otherwise.

Accordingly, there is a need for an olfactory system and methods to provide the aroma related to particular meals.

### SUMMARY OF THE INVENTION

An embodiment includes an olfactory system comprising: an olfactory device comprising a processing unit, a water reservoir, and a heating element; an olfactory medium inserted within the olfactory device and located in a path of fluid flow from the water reservoir and out a nozzle of the olfactory device; and an olfactory receptacle, wherein the olfactory device is controlled by the processing unit to heat water from the water reservoir and dispenses the hot water through the olfactory medium and out of a nozzle to create a hot olfactory liquid that is received in the olfactory receptacle to produce olfactory steam providing aroma to a dwelling.

Another embodiment includes an olfactory system comprising: an olfactory device comprising a processing unit, a water reservoir, and a heating element; and an olfactory receptable containing an olfactory medium within the olfactory receptacle, wherein the olfactory device is controlled by the processing unit to heat water from the water reservoir and dispense hot water through the nozzle and into the olfactory receptacle to engage the olfactory medium to create a hot aroma liquid within the olfactory receptacle to produce olfactory steam providing aroma to a dwelling.

Another embodiment includes a method of providing aroma corresponding to a meal, the method comprising: inserting an aroma pod into an olfactory device, the aroma pod corresponding to a desired meal; flowing heated water through the aroma pod in response to operating the olfactory device to create a hot aroma liquid; dispensing the hot aroma liquid into an olfactory receptacle; and producing olfactory steam from the hot olfactory liquid to provide aroma to a dwelling.

Another embodiment includes an olfactory system comprising: an olfactory receptable containing an olfactory medium within the olfactory receptacle and a removable lid coupled to the olfactory receptacle; and an activator, wherein the lid of the olfactory receptacle is removed and the activator engages the olfactory medium contained within the olfactory receptacle to produce olfactory steam providing aroma to a dwelling.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1A is a diagrammatic view of an olfactory system with an aroma medium located in an olfactory device according to an embodiment;

FIG. 1B is a diagrammatic view of an olfactory system with an aroma medium located in an olfactory device, the olfactory device connected to a user computing device according to an embodiment;

FIG. 2 is a side view of an olfactory system shown in FIG. 1A according to an embodiment;

FIG. 3 is a side view of an olfactory system shown in FIG. 1B according to an embodiment;

FIG. 4 is a perspective view of aroma pods of an olfactory system according to an embodiment;

FIG. 5A is a diagrammatic view of an olfactory system with an aroma medium located in an olfactory receptacle according to an embodiment;

FIG. 5B is a diagrammatic view of an olfactory system with an aroma medium located in an olfactory receptacle and an olfactory device connected to a user computing device according to an embodiment;

FIG. 6 is a side view of an olfactory system shown in FIG. 5A according to an embodiment;

FIG. 7 is a side view of an olfactory system shown in FIG. 5B according to an embodiment;

FIG. 8 is a view of a flow chart depicting a method of providing an aroma corresponding to a meal using an olfactory system according to an embodiment;

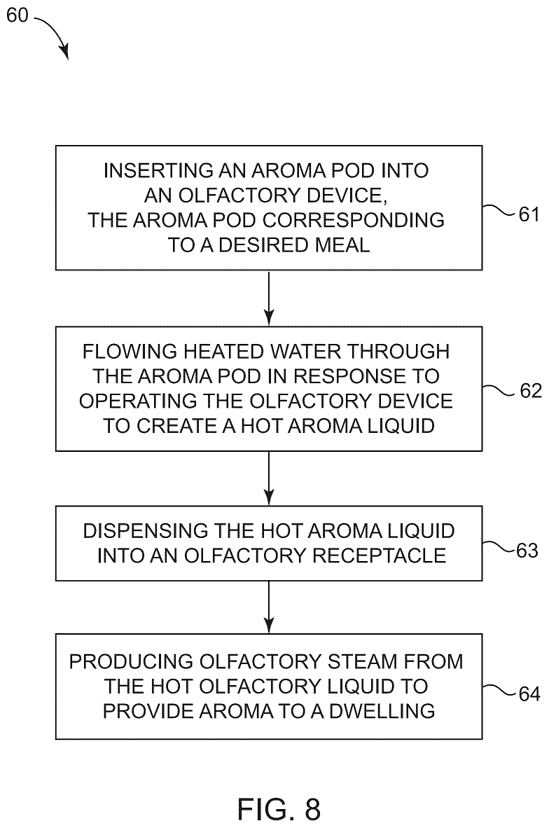

FIG. 9 is a diagrammatic view of an olfactory system with an aroma medium located in an olfactory receptacle according to an embodiment;

FIG. 10A is a perspective view of operation of an olfactory system activating an aroma pod according to an embodiment;

FIG. 10B is a perspective view of aroma emanating from an activated aroma pod according to an embodiment;

FIG. 11 is a perspective view of operation of an olfactory system activating an aroma pod according to an embodiment;

FIG. 12 is a perspective view of operation of an olfactory system activating an aroma pod according to an embodiment;

FIG. 13 is a perspective view of aroma pods of an olfactory system according to an embodiment;

FIG. 14 is a perspective view of an aroma pod of an olfactory system provided as part of a meal kit or purchased with groceries according to an embodiment;

FIG. 15 is a perspective view of an aroma pod located in a delivered meal to enhance the aroma of the meal according to an embodiment; and

FIG. 16 is a perspective view of an olfactory medium formed as part of the olfactory receptacle that may be the food container, according to an embodiment.

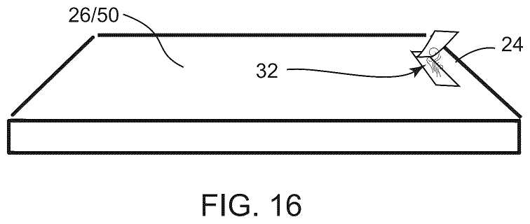

### DETAILED DESCRIPTION OF EMBODIMENTS OF THE INVENTION

As discussed above, it is understood that our sense of smell is responsible for about 80% of what we taste. Without our sense of smell, our sense of taste is limited to only five distinct sensations: sweet, salty, sour, bitter and umami (or savory sensation). Generally, all other flavors are experienced from smell. Smell and taste are part of the same interconnected sensory system, and “flavor” is almost entirely sensed in the nose. Smell (olfactory sense) and taste (gustatory sense) fall work in similar ways. Additionally, the flavor of food is almost entirely detected in the nose and not the tongue. The taste receptors on the tongue and the odorant receptors in the nose work together to tell us about the air we breathe and the food we eat.

Further as mentioned above, many bakeries will use a vent from the oven and pump the scent into the front of the store, so as soon as a customer walks in, he or she can smell a freshly baked good, which in turn can help with impulse sales and increase revenue. Subconsciously, just by smell, customers are compelled to buy something. A scent has triggered memory, and that memory has triggered a sale before anything has even been tasted.

Because smell is such an important part of taste, embodiments of the present invention relate to an olfactory system and method of supplying aroma related to particular meals, especially in regard to meals that delivered or to meal kits.

Olfactory System with Olfactory Device

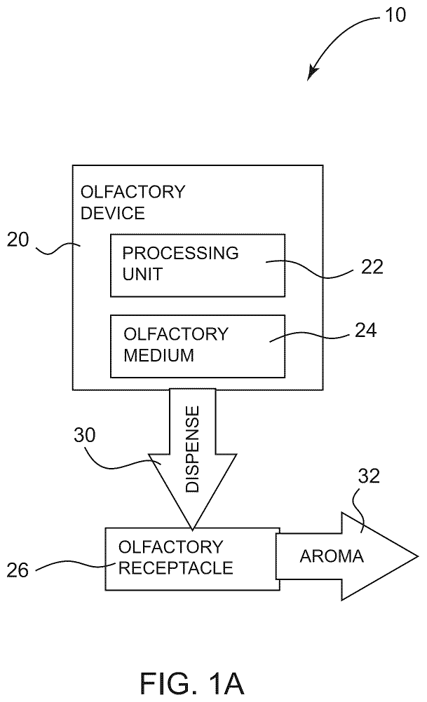

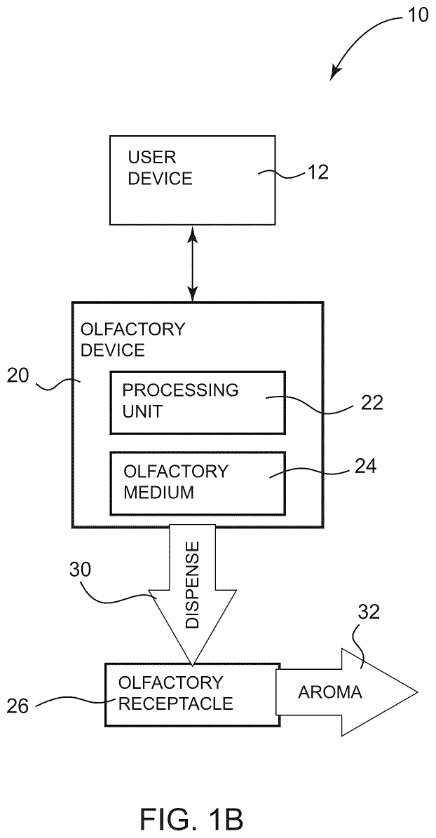

Referring to the drawing figures, FIGS. 1A-1B depict an embodiment of an olfactory system 10. The system 10 comprises an olfactory device 20 that has a processing unit 22. The processing unit 22 may include a memory and processor for processing information entered by a user and operates to control the olfactory device 20 in response to input from the user and execution of software or code stored on the memory of the processing unit 22. The system 10 may further include an olfactory medium 24, such as an aroma pod 24, that may be removably coupled to the olfactory device. The system 10 may also include an olfactory receptacle 26. The olfactory device 20 may include a water reservoir and a heating element. In operation, the olfactory device 20 heats the water from the reservoir and dispenses the hot water through the olfactory medium 24 and out of a nozzle to create a hot olfactory liquid 30.

In some embodiments, as shown in FIG. 1B, the system 10 may also include a user computing device 12 coupled to the olfactory device 20. This coupling may be a network connection, such as a wireless connection through an Internet connection, a Wi-Fi connection, a Bluetooth connection or the like, wherein the user computing device 12 may communicate with and receive communication from the olfactory device 20. The user computing device 12 may include a desktop computer, a laptop, a tablet, a smartphone, wearable devices and the like.

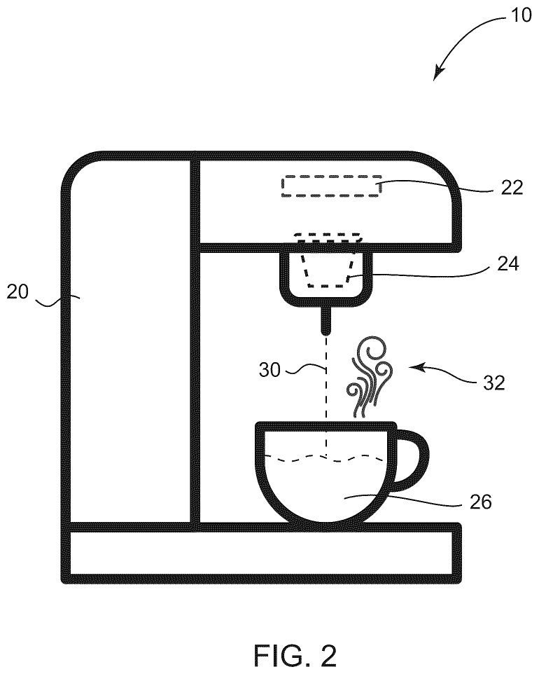

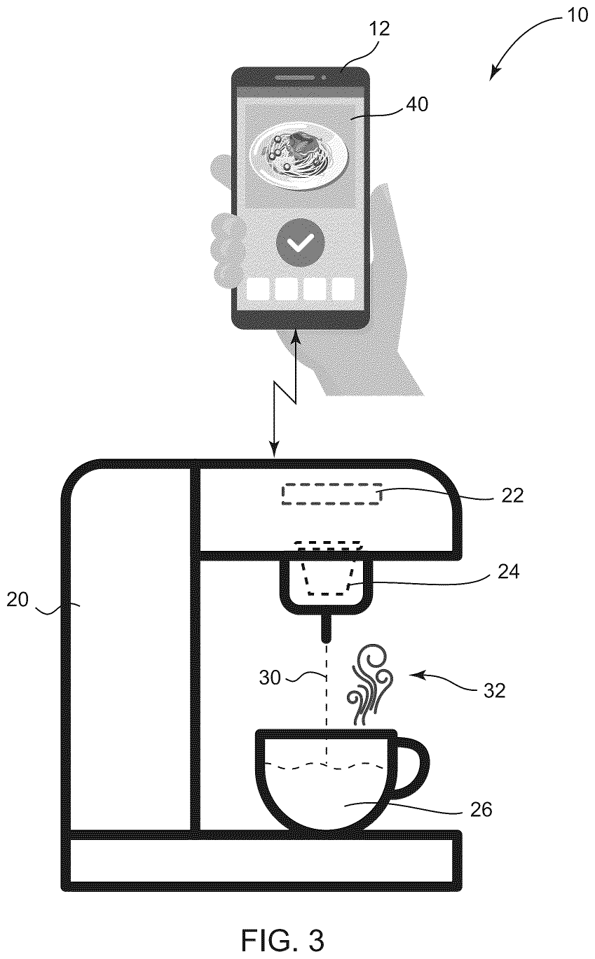

Referring additionally to FIGS. 2-3, the olfactory system 10 may be operated to provide aroma for such reasons as corresponding to a meal to be delivered. Referring specifically to FIGS. 1A and 2, an example of operation of the system 10 is depicted. A user may order a meal for delivery, such as a pasta meal. The user may then insert the olfactory medium 24 or aroma pod 24 into the olfactory device 20, wherein the aroma pod 24 corresponds to the type of meal being ordered. The user may then input instructions using a user interface of the olfactory device 20, wherein the user may then activate operation of the olfactory device 20 by engaging a button or soft button on the user interface. The processing unit 22 will then operate the olfactory device 20 by executing code and corresponding to the user input. The operation of the olfactory device 20 flows hot water through the aroma pod 20 and dispenses hot aroma liquid 30 into the olfactory receptacle 26, such as, but not limited to, a mug as depicted in FIG. 2. The hot aroma liquid 30 then produces steam aroma 32 that fills a dwelling.

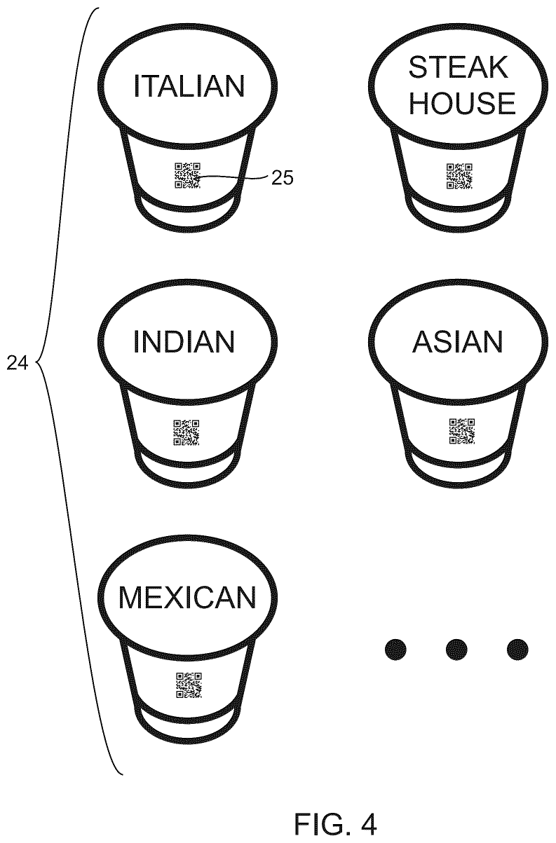

Referring specifically to FIGS. 1B and 3, an example of operation of the system 10 is depicted. A user may order a meal for delivery using a meal order app, such as a pasta meal, using a user computing device 12. The user may then insert the olfactory medium 24 or aroma pod 24 into the olfactory device 20, wherein the aroma pod 24 corresponds to the type of meal being ordered. In embodiments, an olfactory app operating on the user computing device 12 may receive information related to the ordered meal and recommend an aroma pod 24 that corresponds to the ordered meal. Further, the aroma pods 24 may have codes 25 on the aroma pod (see FIG. 4) that may be scanned by the user computing device 12 using a camera of the user computing device 12 to confirm the recommended aroma pod 24 is being inserted into the olfactory device 20. Further, the olfactory device 20 may be a smart device that can scan the code 25 of the inserted aroma pod 24 and communicate with the user computing device 12 whether the recommended aroma pod 24 was inserted. The user may then input instructions using a user interface of the olfactory device 20, wherein the user may then activate operation of the olfactory device 20 by engaging a button or soft button on the user interface. Alternatively, the user computing device 12 may be utilized to enter the instruction either automatically, or through user interaction with the olfactory app operating on the user computing device 12. The processing unit 22 will then operate the olfactory device 20 by executing code and corresponding to the user input. The operation of the olfactory device 20 flows hot water through the aroma pod 20 and dispenses hot aroma liquid 30 into the olfactory receptacle 26, such as, but not limited to, a mug as depicted in FIG. 3. The hot aroma liquid 30 then produces steam aroma 32 that fills a dwelling.

In some embodiments as depicted in FIGS. 1B and 3, the system 10 is a smart system and the user computing device 12 may communicate an estimated delivery time of the ordered and update the estimated delivery time based on information received from the meal order app operating on the user computing device 12. The processing unit 22 may then initiate operation and dispensing of the hot aroma liquid 30 at a predetermined time before delivery of the ordered meal, thereby simulating preparation of the meal and the aromas that fill a dwelling during cooking of the corresponding meal and providing a home-cooked meal experience using all of the senses.

The olfactory medium 24 or aroma pod 24, may correspond to different types of food. As depicted in FIG. 4, examples, without limitation, of these types of meals include Italian, Steak House, Indian, Asian, Mexican and any other type of meal. These aroma pods 24 may be filled with ingredients that are configured to have the spices and aromas associated with the type of food depicted on the aroma pod 24. The olfactory device 20 can pierce the aroma pod 24 to allow fluid to flow through the aroma pod 24 and exit the olfactory device 20 through a nozzle. In operation, the olfactory device 20 heats the water from the reservoir and dispenses the hot water through the olfactory medium 24 and out of a nozzle to create a hot olfactory liquid 30. It will be understood that in embodiments, the hot olfactory liquid 30 is not intended for consumption, but is safe if unintentionally consumed.

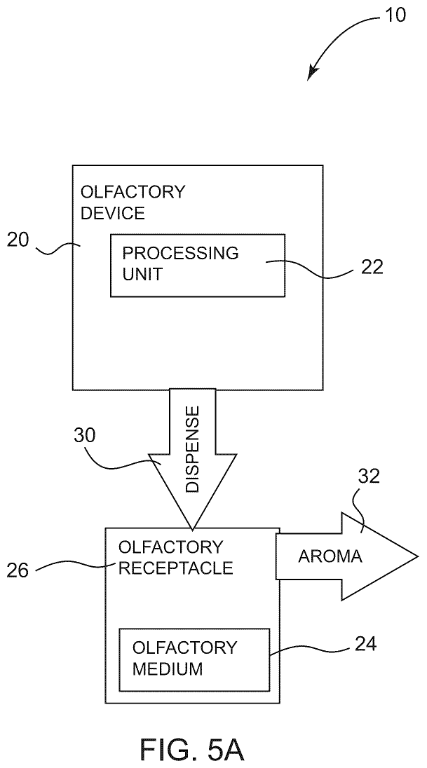

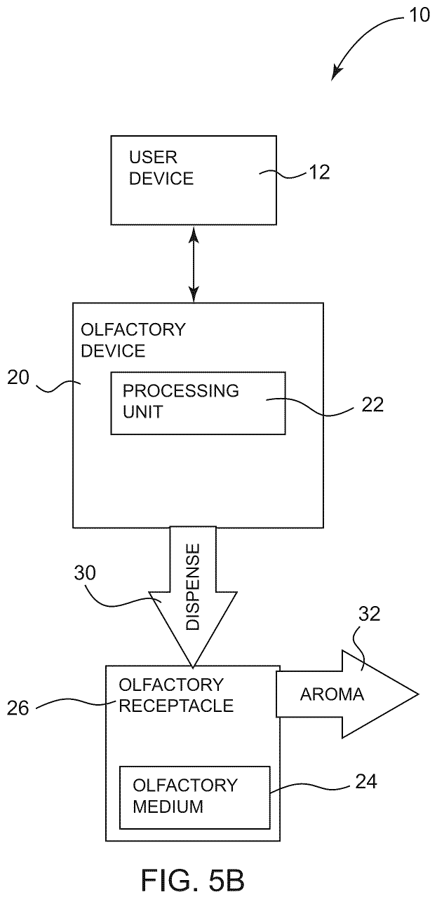

Referring to the drawing figures, FIGS. 5A-5B depict an embodiment of an olfactory system 10. The system 10 comprises an olfactory device 20 that has a processing unit 22. The processing unit 22 may include a memory and processor for processing information entered by a user and operates to control the olfactory device 20 in response to input from the user and execution of software or code stored on the memory of the processing unit 22. The system 10 may further include an olfactory receptable 26 containing an olfactory medium 24. The olfactory device 20 may include a water reservoir and a heating element. In operation, the olfactory device 20 heats the water from the reservoir and dispenses the hot water out of a nozzle and into the olfactory receptacle 26 and engages the olfactory medium 24 to create a hot olfactory liquid 30.

In some embodiments, as shown in FIG. 5B, the system 10 may also include a user computing device 12 coupled to the olfactory device 20. This coupling may be a network connection, such as a wireless connection through an Internet connection, a Wi-Fi connection, a Bluetooth connection or the like, wherein the user computing device 12 may communicate with and receive communication from the olfactory device 20. The user computing device 12 may include a desktop computer, a laptop, a tablet, a smartphone, wearable devices and the like.

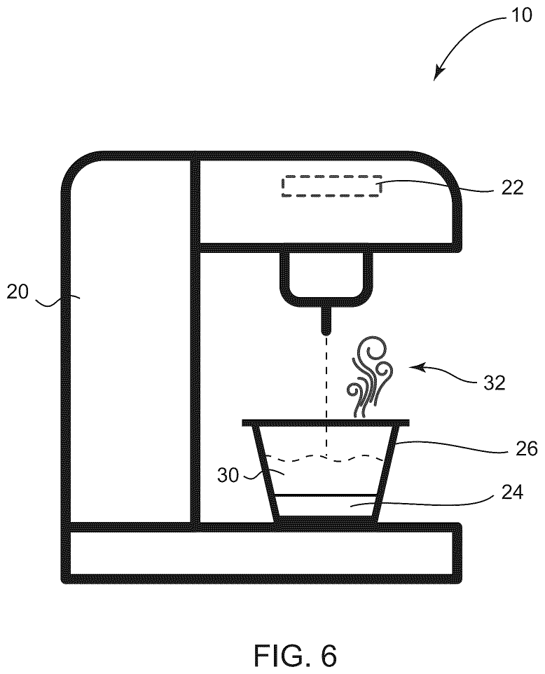

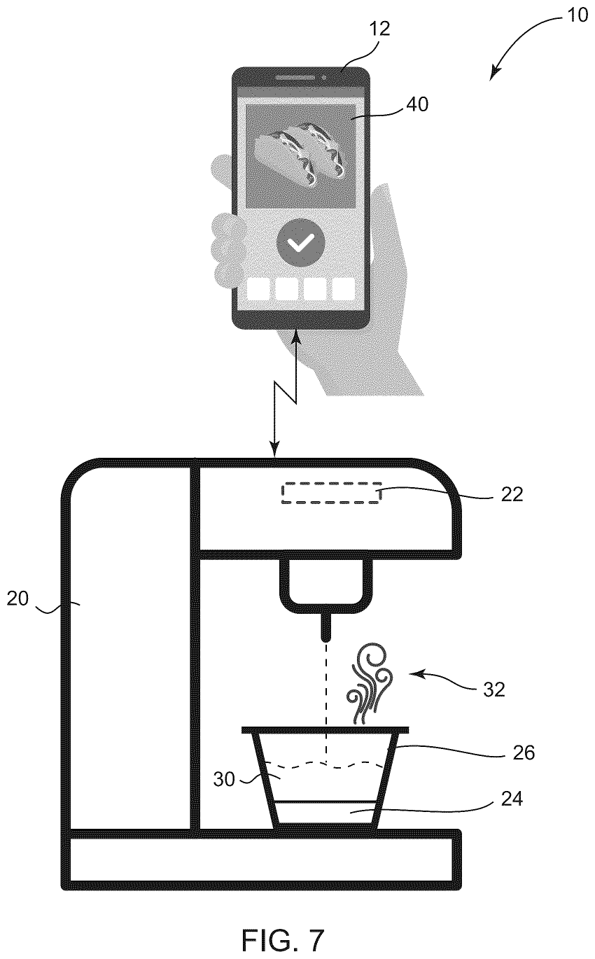

Referring additionally to FIGS. 6-7, the olfactory system 10 may be operated to provide aroma for such reasons as corresponding to a meal to be delivered. Referring specifically to FIGS. 5A and 6, an example of operation of the system 10 is depicted. A user may order a meal for delivery, such as tacos. The user may then place the olfactory receptable 26 containing the olfactory medium 24 under a nozzle of the olfactory device 20, wherein the olfactory medium 24 corresponds to the type of meal being ordered. The user may then input instructions using a user interface of the olfactory device 20, wherein the user may then activate operation of the olfactory device 20 by engaging a button or soft button on the user interface. The processing unit 22 will then operate the olfactory device 20 by executing code and corresponding to the user input. The operation of the olfactory device 20 dispenses hot water through the nozzle and into the olfactory receptacle 26 to engage the olfactory medium to create the hot aroma liquid 30 within the olfactory receptacle 26 as depicted in FIG. 6. The hot aroma liquid 30 then produces steam aroma 32 that fills a dwelling.

Referring specifically to FIGS. 5B and 7, an example of operation of the system 10 is depicted. A user may order a meal for delivery using a meal order app, such as a pasta meal, using a user computing device 12. The user may then place the olfactory receptable 26 containing the olfactory medium 24 under a nozzle of the olfactory device 20, wherein the olfactory medium 24 corresponds to the type of meal being ordered. In embodiments, an olfactory app operating on the user computing device 12 may receive information related to the ordered meal and recommend an olfactory receptacle 26 containing an olfactory medium 24 that corresponds to the ordered meal. Further, the olfactory receptacles 26 may have codes similar to the codes depicted in FIG. 4 that may be scanned by the user computing device 12 using a camera of the user computing device 12 to confirm the recommended aroma pod 24 is being inserted into the olfactory device 20. Further, the olfactory device 20 may be a smart device that can scan the code 25 of the olfactory receptacle 26 and communicate with the user computing device 12 whether the recommended olfactory medium 24 is being utilized. The user may then input instructions using a user interface of the olfactory device 20, wherein the user may then activate operation of the olfactory device 20 by engaging a button or soft button on the user interface. Alternatively, the user computing device 12 may be utilized to enter the instruction either automatically, or through user interaction with the olfactory app operating on the user computing device 12. The processing unit 22 will then operate the olfactory device 20 by executing code and corresponding to the user input. The operation of the olfactory device 20 dispenses hot water through the nozzle and into the olfactory receptacle 26 to engage the olfactory medium to create the hot aroma liquid 30 within the olfactory receptacle 26 as depicted in FIG. 7. The hot aroma liquid 30 then produces steam aroma 32 that fills a dwelling.

In some embodiments as depicted in FIGS. 5B and 7, the system 10 is a smart system and the user computing device 12 may communicate an estimated delivery time of the ordered and update the estimated delivery time based on information received from the meal order app operating on the user computing device 12. The processing unit 22 may then initiate operation and dispensing of the hot water to create the hot aroma liquid 30 at a predetermined time before delivery of the ordered meal, thereby simulating preparation of the meal and the aromas that fill a dwelling during cooking of the corresponding meal and providing a home-cooked meal experience using all of the senses.

The olfactory medium 24 may correspond to different types of food similar to the aroma pods depicted in FIG. 4 and described above with regard to FIG. 4. It will be understood that in embodiments, the hot olfactory liquid 30 is not intended for consumption but is safe if unintentionally consumed.

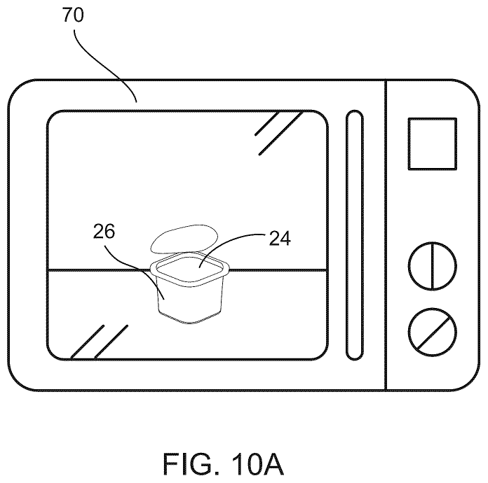

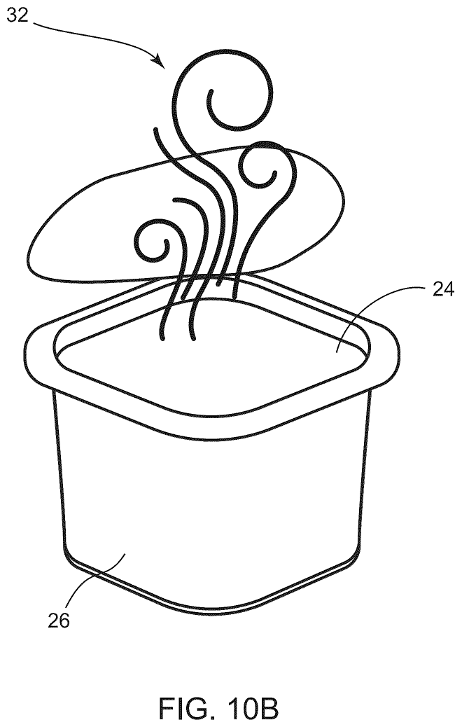

Another embodiment, as shown in FIG. 10, comprises a method 60 of providing aroma corresponding to a meal. The method 60 comprises inserting an aroma pod into an olfactory device, the aroma pod corresponding to a desired meal (Step 61); flowing heated water through the aroma pod in response to operating the olfactory device to create a hot aroma liquid (Step 62); dispensing the hot aroma liquid into an olfactory receptacle (Step 63); and producing olfactory steam from the hot olfactory liquid to provide aroma to a dwelling (Step 64).

Olfactory System without Olfactory Device

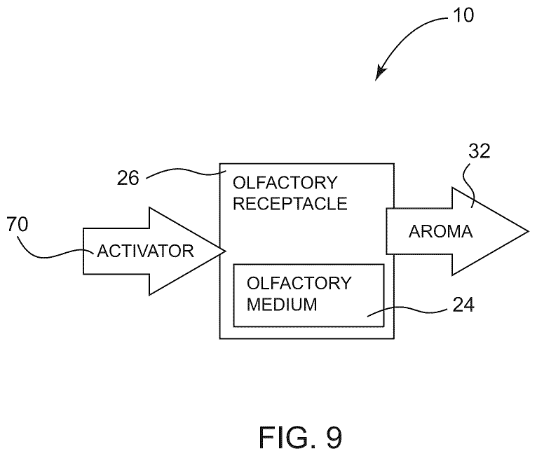

Referring to the drawing figures, FIG. 9 depicts an embodiment of an olfactory system 10. The system 10 comprises an olfactory receptable 26 containing an olfactory medium 24. The system 10 also includes an activator 70 that activates the olfactory medium 24 contained by the olfactory receptacle 26 to generate aroma 32 and is dispersed throughout a dwelling or a portion thereof.

Referring additionally to FIGS. 10A-12, the olfactory system 10 may be operated to provide aroma for such reasons as corresponding to a meal to be delivered. Referring specifically to FIGS. 9-10B, an example of operation of the system 10 is depicted. A user may order a meal for delivery, such as a pasta meal. In embodiments, an olfactory app operating on the user computing device 12 may receive information related to the ordered meal and recommend an olfactory receptacle 26 containing an olfactory medium 24 that corresponds to the ordered meal. The user may then place the olfactory receptable 26 containing the olfactory medium 24 in a microwave operating as an activator 70 to activate the olfactory medium using heat from the microwave, wherein the olfactory medium 24 corresponds to the type of meal being ordered. The user may then input instructions using a user interface of the microwave, wherein the user may then activate operation of the microwave to supply heat to the olfactory medium 24 within the olfactory receptacle 26. In embodiments, the lid of the olfactory receptacle 26 is open during activation to prevent damage to the receptacle 26. After a predetermined amount of time operating the microwave as the activator 70, the olfactory receptacle 26 may be removed from the microwave and place in a location that allows aroma 32 to emanate from the olfactory medium 24 contained by the olfactory receptacle 26 that fills a dwelling.

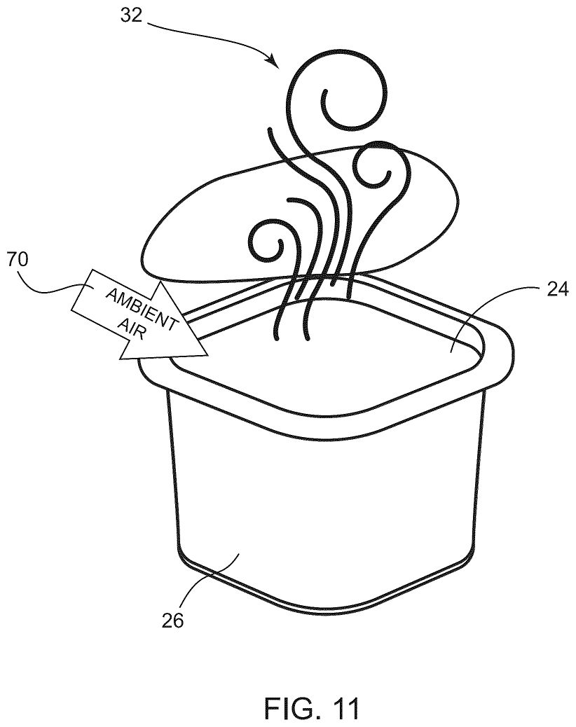

Referring specifically to FIGS. 9 and 11, an example of operation of the system 10 is depicted. A user may order a meal for delivery using a meal order app, such as a pasta meal, using a user computing device 12. The user may then place the olfactory receptable 26 containing the olfactory medium 24 in a desired location to provide aroma to the dwelling, wherein the olfactory medium 24 corresponds to the type of meal being ordered. In embodiments, an olfactory app operating on the user computing device 12 may receive information related to the ordered meal and recommend an olfactory receptacle 26 containing an olfactory medium 24 that corresponds to the ordered meal. In operation, the removal of the lid allows the activator 70, which is shown as ambient air in the example of FIG. 11, to activate the olfactory medium 24. This activation of the olfactory medium 24 allows aroma 32 to emanate from the olfactory medium 24 contained by the olfactory receptacle 26 that fills a dwelling.

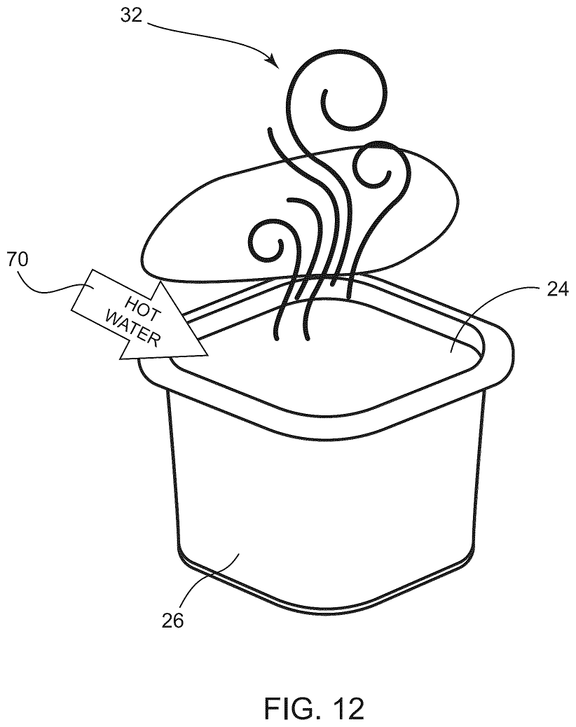

Referring specifically to FIGS. 9 and 12, an example of operation of the system 10 is depicted. A user may order a meal for delivery using a meal order app, such as a pasta meal, using a user computing device 12. The user may then place the olfactory receptable 26 containing the olfactory medium 24 in a desired location to provide aroma to the dwelling, wherein the olfactory medium 24 corresponds to the type of meal being ordered. In embodiments, an olfactory app operating on the user computing device 12 may receive information related to the ordered meal and recommend an olfactory receptacle 26 containing an olfactory medium 24 that corresponds to the ordered meal. In operation, the removal of the lid allows the activator 70, which is shown as hot water in the example of FIG. 12, to be poured onto the olfactory medium 24 to activate it. This activation of the olfactory medium 24 allows aroma 32 to emanate from the olfactory medium 24 contained by the olfactory receptacle 26 that fills a dwelling.

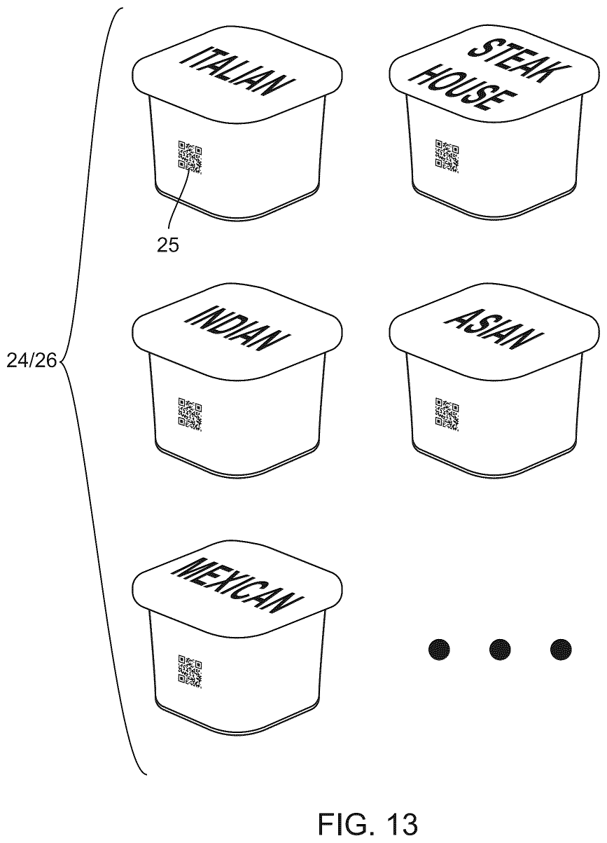

The olfactory medium 24 within the olfactory receptacle 26 form an aroma pod, and may correspond to different types of food. As depicted in FIG. 13, examples, without limitation, of these types of meals include Italian, Steak House, Indian, Asian, Mexican and any other type of meal. These olfactory receptacles 26 may be filled with ingredients that are configured to have the spices and aromas as the olfactory medium 24 associated with the type of food depicted on a lid of the olfactory receptacle 26. The lid of the olfactory receptacle 26 may be removed to expose the olfactory medium 24 and the activator 70 may then operate to activate the olfactory medium 24 that has been exposed. It will be understood that in embodiments, the olfactory medium 24 is not intended for consumption, but is safe if unintentionally consumed.

In embodiments, the olfactory receptacles 26 may have codes 25 on the receptacles 26 (see FIG. 13) corresponding to the olfactory medium 24 contained in the olfactory receptacle 26. The code 25 may be scanned by the user computing device 12 using a camera of the user computing device 12 to confirm the recommended aroma pod is being utilized.

The olfactory system 10 may be incorporated into other ways of enhancing the olfactory experience of any meal, including meal kits. In embodiments, as shown in FIG. 13, an aroma pod 24 may be included in a meal kit 60. This olfactory receptacle 26 with olfactory medium 24 forming the aroma pod may be utilized to supplement the aroma of the home cooked meal by using the aroma pod during cooking. Additionally, order may use the aroma pod if the user has leftovers and eats the meal a different night, wherein utilization of the aroma pod provides the full experience again.

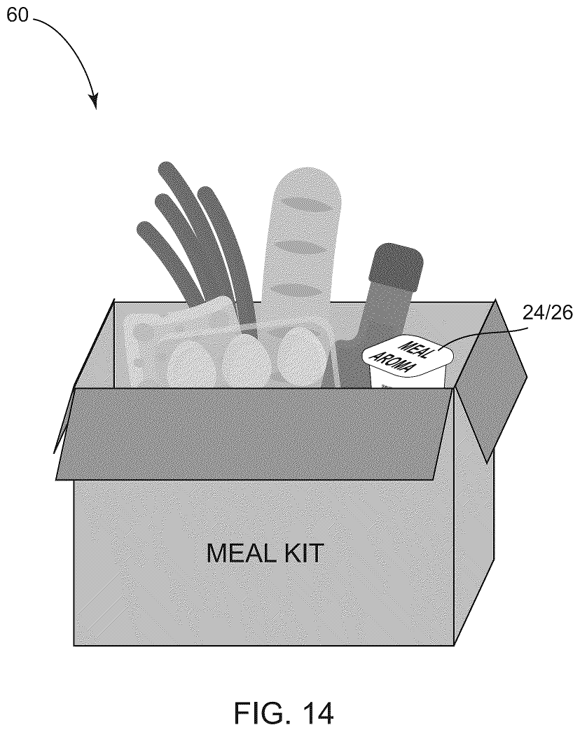

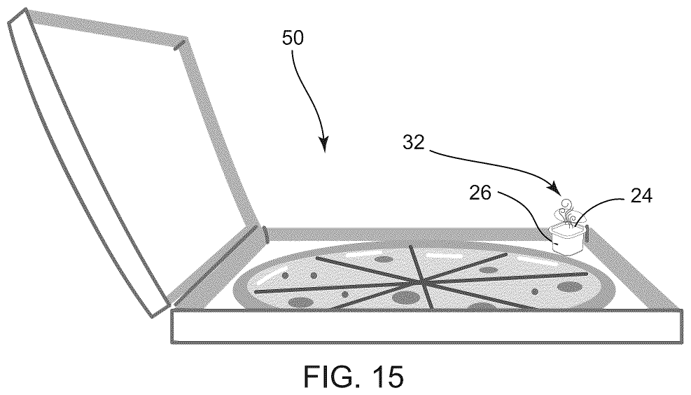

Additionally, some meals that are delivered may need aroma enhanced in a different manner. As shown in FIG. 14, an aroma pod formed by the olfactory receptacle 26 containing the olfactory medium 24 may be incorporated into a meal container 50 that when the meal container 50 is opened the lid of the olfactory receptacle 26 may be removed and the activator 70 activates the olfactory medium 24 to provide aroma 32 that enhances the aroma from the food within the container 50. Further, as shown in FIG. 15 the olfactory receptacle 26 may be the food container 50 and the olfactory medium 24 may be applied to the container 50, wherein a cover film may be peeled back to expose the olfactory medium 24 with ambient air as an activator 70 to provide aroma 32

Another embodiment, as shown in FIG. 10, comprises a method 60 of providing aroma corresponding to a meal. The method 60 comprises inserting an aroma pod into an olfactory device, the aroma pod corresponding to a desired meal (Step 61); flowing heated water through the aroma pod in response to operating the olfactory device to create a hot aroma liquid (Step 62); dispensing the hot aroma liquid into an olfactory receptacle (Step 63); and producing olfactory steam from the hot olfactory liquid to provide aroma to a dwelling (Step 64).

Embodiments may be available on or through the internet, such as through domain names reserved and owned by Applicant that include smellsgood.app, momscooking.app, mmgood.app, 5senses.app, olfactory.live, whatscooking.live, smellgood.ai, momscooking.ai, mmgood.ai, cookingallday.ai, mom-cooking.com, instasmell.com, instaolfactory.com, dinners-ready.com, smellsgoodapp.com or the like.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An olfactory system comprising:
an olfactory device comprising a processing unit, a water reservoir, and a heating element;
an olfactory medium inserted within the olfactory device and located in a path of fluid flow from the water reservoir and out a nozzle of the olfactory device; and
an olfactory receptacle, wherein the olfactory device is controlled by the processing unit to heat water from the water reservoir and dispenses the hot water through the olfactory medium and out of a nozzle to create a hot olfactory liquid that is received in the olfactory receptacle to produce olfactory steam providing aroma to a dwelling.

2. The system of claim 1, wherein the olfactory medium is an aroma pod.

3. The system of claim 2, the aroma pod corresponds to a particular type of food.

4. The system of claim 3, wherein the aroma pod further comprises a scannable code to confirm the aroma pod corresponds to a desired type of food.

5. The system of claim 4, further comprising a user computing device coupled to the olfactory device.

6. The system of claim 5, wherein the user computing device comprises an olfactory app operating on the user computing device to communicate with and receive communication from the olfactory device.

7. The system of claim 6, wherein the olfactory app receives information on a meal ordered with a meal order app operating on the user computing device and recommends an aroma pod corresponding to the ordered meal.

8. A method of providing aroma corresponding to a meal, the method comprising:
inserting an aroma pod into an olfactory device, the aroma pod corresponding to a desired meal;
flowing heated water through the aroma pod in response to operating the olfactory device to create a hot aroma liquid;
dispensing the hot aroma liquid into an olfactory receptacle; and
producing olfactory steam from the hot olfactory liquid to provide aroma to a dwelling.

9. An olfactory system comprising:
an olfactory receptable containing an olfactory medium within the olfactory receptacle and a removable lid coupled to the olfactory receptacle;
and an activator, wherein the lid of the olfactory receptacle is removed and the activator engages the olfactory medium contained within the olfactory receptacle to produce olfactory steam providing aroma to a dwelling.

10. The system of claim 9, the olfactory medium corresponds to a particular type of food.

11. The system of claim 10, wherein the olfactory receptacle further comprises a scannable code to confirm the olfactory medium within the olfactory receptacle corresponds to a desired type of food.

12. The system of claim 11, wherein the user computing device comprises an olfactory app operating on the user computing device to receive meal order information from a meal order app operating on the user computing device.

13. The system of claim 12, wherein the olfactory app receives information on a meal ordered with a meal order app operating on the user computing device and recommends an olfactory receptacle with olfactory medium corresponding to the ordered meal.

14. The system of claim 6, wherein the scannable code of the aroma pod is scanned by the user computing device using a camera of the user computing device to confirm the aroma pod of the desired type of food is being inserted into the olfactory device.

15. The system of claim 14, wherein the olfactory device is a smart device performing artificial intelligence function to scan the scannable code of the inserted aroma pod and communicate with the user computing device whether the inserted aroma pod is the aroma pad of the desired type of food.
